(19) United States
(12) Patent Application Publication
(10) Pub. No.: US 2015/0358251 A1
(43) Pub. Date: Dec. 10, 2015

(54) UNIFIED CLOUD RESOURCE CONTROLLER

(71) Applicant: NOKIA SOLUTIONS AND NETWORKS OY, Espoo (FI)

(72) Inventors: Jozsef VARGA, Nagydobsza (HU); Jozsef BIRO, Budapest (HU); Lorant NEMETH, Budapest (HU); Krisztian SINKA, Budapest (HU); Vilmos Csaba ROTTER, Pomáz (HU)

(21) Appl. No.: 14/762,832

(22) PCT Filed: Jan. 24, 2014
(86) PCT No.: PCT/EP2014/051353

§ 371 Date: Jul. 23, 2015

Related U.S. Application Data
(60) Provisional application No. 61/756,647, filed on Jan. 25, 2013.

(51) Int. Cl. H04L 12/911; H04L 29/08

(52) U.S. Cl. CPC H04L 47/72; H04L 67/10

(57) ABSTRACT

There are provided measures for unified cloud resource control. Such measures exemplarily comprise receiving a request specifying resource requirements of a resource combination of multiple resource types, and controlling reservation of infrastructure resources out of a pool of infrastructure resources according to said resource requirements.

### FIELD

The present invention relates to cloud computing and especially the Infrastructure as a Service (IaaS) as a cloud computing service model.

IaaS related terms are defined in e.g. http://csrc.nist.gov/publications/nistpubs/800-145/SP800-145.pdf.

The present invention in particular relates to unified cloud resource control. More specifically, the present invention exemplarily relates to measures (including methods, apparatuses and computer program products) for realizing unified cloud resource control.

### BACKGROUND

IaaS is a cloud computing service model that offers consumer processing, storage, networks, and other fundamental computing resources, where the consumer is able to e.g. deploy and run arbitrary software, which can include for example operating systems and applications. The consumer does not manage or control the underlying cloud infrastructure, but has control over the deployed operating systems and applications, the storage, and possibly limited control of select networking components (e.g., host firewalls). Popular and well-known IaaS service providers are for example Amazon, RackSpace, and FlexiScale. Many smaller providers are also emerging in this very dynamic field.

Furthermore, there are many service offerings and software applications that offer enhancements on top of the basic IaaS model, e.g. configuration, automation, management and orchestration tools/services that ease various aspects of the handling of the resources offered by IaaS clouds.

Examples of such offers are RightScale or enStratus.

Major IaaS application programming interfaces (API) work at elementary resource level exclusively. JClouds has the notion of node sets, but that is aggregated from a set of individual virtual machines (VM), and the operation is actually decomposed into elementary calls.

Further, service and application deployment is generally seen as a task that must be built on top of an IaaS API (e.g. enStratus, RightScale). However, these solutions decompose the resource reservations into individual steps, and there are no guarantees that the sequence of reservations will succeed, and thus a failure at one point means that earlier reservations must be revoked (and reattempted if needed).

The open virtualization format (OVF) allows packaging together the description of a set of cooperating VMs as a “virtual appliance” and it defines related resources used by this VM set. However, OVF concentrates on defining the software (SW) stack on top of the VMs and it does not mandate anything about the deployment sequence of the defined virtual appliance. In practice, OVF is used mostly for deploying appliances over virtualization infrastructures (as opposed to IaaS clouds) and deployment is executed in a stepwise manner, i.e. the implicit knowledge about the complete resource requirement of the appliance is not exploited.

Furthermore, state of the art IaaS solutions support the definition of virtual networks and connecting VMs thereto. However, resources that can be allocated to these networks are merely logical (e.g. internet protocol (IP) address, virtual local area network (VLAN) identifier (ID)), and only enable separation of the traffic. The assignment of logical resources does not impose any restriction on where VMs (and assigned physical resources) can be deployed.

OpenStack (http://wiki.openstack.org/StartingPage?action=show&redirect=OpenStack) has different modules to handle different types of resources (i.e. the Nova module is for computing resources, Quantum module for networking, Swift module and Cinder module for storage), but these are independent modules. Even though Quantum module claims the possibility of providing end to end quality of service (QoS) for virtual network, it is not clear how it can be achieved with current overlay model, and even if it would be achievable, how the network resource restrictions affect the replacement of VMs.

In addition, VM placement decisions are done based on the availability of the hardware resources that IaaS is aware of. In most of the cases this is limited to central processing unit (CPU), memory, and local disk capacity. The physical network resources interconnecting the host machines are not known to the IaaS.

Hence, the problem arises that existing measures in the field almost completely lack the support of handling physical networking resources (and none of them supports networking with QoS guarantees), and consider resource reservation for an application deployment in the cloud as a sequence of elementary resource reservations that may result in a failure (see FIG. 5 and FIG. 6) or in a poor utilization of resources.

FIG. 5 presents a prior art architecture wherein resources are controlled by several functionalities, and clients have to deal with those separately.

FIG. 6 presents a prior art measure, in particular a scenario where the client attempts to reserve resources one by one, which results in a failed attempt (and the need for a second attempt where the client may try to modify the resource request). In particular, fragmented resource reservation according to prior art techniques is illustrated (failure is indicated to the client(s) although resources may be available).

In particular, even though the data center network is part of the data center infrastructure as one of the fundamental cloud computing resources, and in this aspect should be controlled by the IaaS, the state-of-the-art IaaS implementations do not support networking QoS requirements (e.g. guaranteed bandwidth, delay) between computational instances, i.e., virtual machines (VMs).

Further, IaaS APIs present infrastructure resources (CPU, memory, storage, network) as distinct entities that can be reserved only one by one. However, real world applications require a combination of elementary resources (e.g. a VM, an IP address and a virtual disk for a simple application, a combination of several VMs, disks, etc for more complex applications), so an attempt to reserve these combined resources one by one can result a failure in many cases, and almost certainly a bad utilization of available resources.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method comprising receiving a request specifying resource requirements of a resource combination of multiple resource types, and controlling reservation of infrastructure resources out of a pool of infrastructure resources according to said resource requirements.

According to an exemplary aspect of the present invention, there is provided a method comprising providing reservation capability of infrastructure resources out of a pool of infrastructure resources of a resource type of multiple resource types, and reserving infrastructure resources.

According to an exemplary aspect of the present invention, there is provided an apparatus comprising receiving means configured to receive a request specifying resource requirements of a resource combination of multiple resource types, and controlling means configured to control reservation of infrastructure resources out of a pool of infrastructure resources according to said resource requirements.

According to an exemplary aspect of the present invention, there is provided an apparatus comprising providing means configured to provide reservation capability of infrastructure resources out of a pool of infrastructure resources of a resource type of multiple resource types, and reserving means configured to reserve infrastructure resources.

Any one of the above aspects enables an efficient deployment of complex services with enhanced quality/performance requirements and provides a better resource optimization not only for processing, but also other resources like networking and storage to thereby solve at least part of the problems and drawbacks identified in relation to the prior art.

By way of exemplary embodiments of the present invention, there is provided unified cloud resource control. More specifically, by way of exemplary embodiments of the present invention, there are provided measures and mechanisms for realizing unified cloud resource control.

Thus, improvement is achieved by methods, apparatuses and computer program products enabling/realizing unified cloud resource control.

### BRIEF DESCRIPTION OF THE DRAWINGS

In the following, the present invention will be described in greater detail by way of non-limiting examples with reference to the accompanying drawings, in which

FIG. 1 is a block diagram illustrating an apparatus according to exemplary embodiments of the present invention,

FIG. 2 is a block diagram illustrating an apparatus according to exemplary embodiments of the present invention,

FIG. 3 is a schematic diagram of a procedure according to exemplary embodiments of the present invention,

FIG. 4 is a schematic diagram of a procedure according to exemplary embodiments of the present invention,

FIG. 5 is a schematic diagram illustrating a architecture according to prior art,

FIG. 6 shows a schematic diagram of signaling sequences according to prior art,

FIG. 7 is a schematic diagram illustrating a architecture according to exemplary embodiments of the present invention,

FIG. 8 shows a schematic diagram of signaling sequences according to exemplary embodiments of the present invention,

FIG. 9 shows a schematic diagram of signaling sequences according to exemplary embodiments of the present invention,

FIG. 10 shows a schematic diagram of signaling sequences according to exemplary embodiments of the present invention, and

FIG. 11 shows a schematic diagram of signaling sequences according to exemplary embodiments of the present invention.

### DETAILED DESCRIPTION OF DRAWINGS AND EMBODIMENTS OF THE PRESENT INVENTION

The present invention is described herein with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary configurations and deployments. Namely, the present invention and its embodiments are mainly described in relation to cloud computing scenarios including e.g. a client, Infrastructure as a Service (IaaS) and Network as a Service (NaaS) being used as non-limiting examples for certain exemplary cloud computing configurations and deployments. As such, the description of exemplary embodiments given herein specifically refers to terminology which is directly related thereto. Such terminology is only used in the context of the presented non-limiting examples, and does naturally not limit the invention in any way. Rather, any other cloud computing configuration and deployment, etc. may also be utilized as long as compliant with the features described herein.

Hereinafter, various embodiments and implementations of the present invention and its aspects or embodiments are described using several variants and/or alternatives. It is generally noted that, according to certain needs and constraints, all of the described variants and/or alternatives may be provided alone or in any conceivable combination (also including combinations of individual features of the various variants and/or alternatives).

According to exemplary embodiments of the present invention, in general terms, there are provided measures and mechanisms for (enabling/realizing) unified cloud resource control.

The above mentioned issues (namely, those resulting from that according to the state of the art a client attempts to reserve resources one by one, and IaaS implementations do not support networking QoS requirements) are related to each other. Namely, as long as a cloud provides resources on a “best effort” basis, failures to reserve a set of resources in a sequence are unlikely. In particular, computing and storage capacity of a cloud is usually sufficient, network capacity is a typical bottleneck, but since there are no network QoS promises, reservations are still successful.

However, as soon as resource quality attributes (e.g. network QoS) are introduced, bottleneck resources may impact combined reservations, and if the resource reservation algorithm does not consider the combined topology of the available resources, then resource utilization will be of poor quality.

Hence, according to exemplary embodiments of the present invention, resource reservation for an application deployment in the cloud is considered as a single task.

In the present specification, a cloud means a pool of resources (computing, storage, networking, application, operating system or other) that span across one or more data centers and servers. The cloud enables the users to access these resources on a per need basis.

Further, a data center means a server farm with internal network that aims to supply infrastructure for the customers. The management and supervision of the data center is centralized and is hidden from the customers.

In this specification, for the sake of simplicity of explanation, it is assumed that a cloud is a single data center, so the terms may be used interchangeably. However, the invention may be extended to a case when a cloud expands multiple data centers. That is, when in the present document the term cloud is used, this may mean, according to exemplary embodiments of the present invention, (the resources of) a data center as well as (the resources of) a couple of data centers.

Further, an IaaS controller means functionality to provide control over computing and associated storage resources. It can be an existing private cloud implementation with no or minor modifications. Proposed modifications in this invention report serve better interaction with the proposed new components of the architecture.

Furthermore, a NaaS controller means functionality to provide control over the data center network. Even though the data center network is part of the data center infrastructure, this functionality (if existing at all) is separated in existing implementations.

According to exemplary embodiments of the present invention, an extended architecture for clouds is proposed to enable the deployment of complex services with enhanced quality/performance requirements and to provide a better resource utilisation not only for processing, but also other resources like networking and storage.

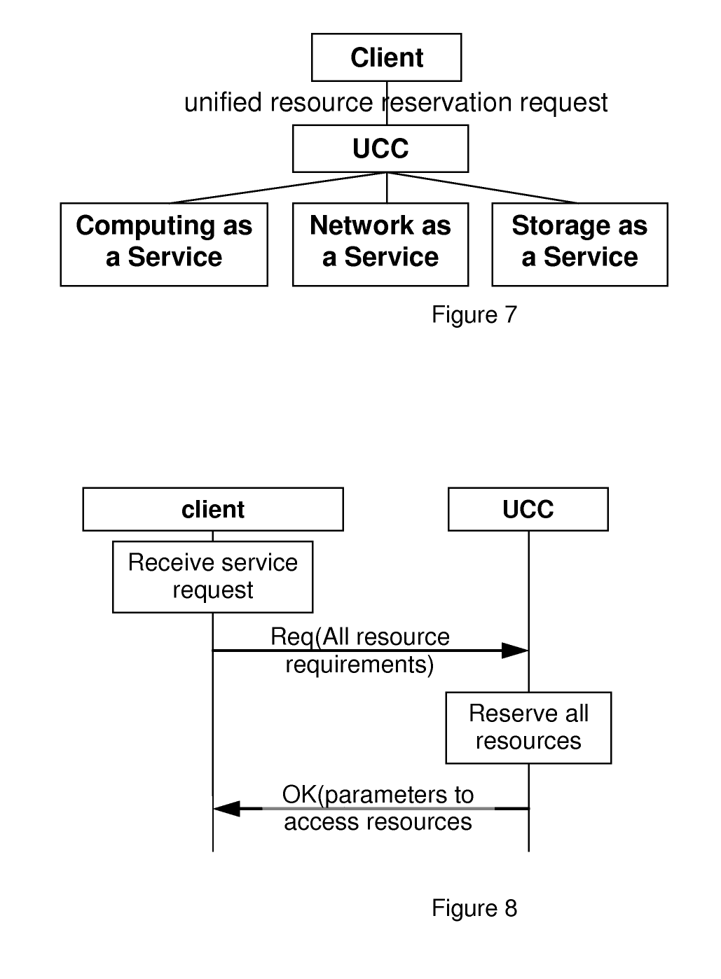

In particular, according to exemplary embodiments of the present invention, the key part of this extension is a new functionality, namely the Unified Cloud resource Controller (UCC), which provides an extended IaaS interface towards clients to enable resource allocation request via an extended IaaS API (see FIG. 7). The extended IaaS API allows the reservation of all cloud infrastructure resources in a single request (see FIG. 8), and the reservations are made guaranteeing good utilization of the cloud infrastructure resources (i.e., the UCC eliminates the fragmentation of the existing resource reservation procedures).

FIG. 7 presents the proposed extended architecture, in particular in relation to the UCC functionality of a unified IaaS interface.

FIG. 8 presents a scenario where a client is served by the UCC (with high level UCC functionality according to exemplary embodiments of the present invention) that fulfills all resource requirements, and that assigns necessary resources in a single step (UCC may interact with legacy resource controllers, but not shown).

To ensure scalability and utilization of a concept for cloud infrastructures expanding multiple data centers, the centralized UCC according to exemplary embodiments of the present invention controls resource reservations in its own administrative domain, while it is able to interface with other UCCs. The administrative domain could scale from a data center part to multiple data centers.

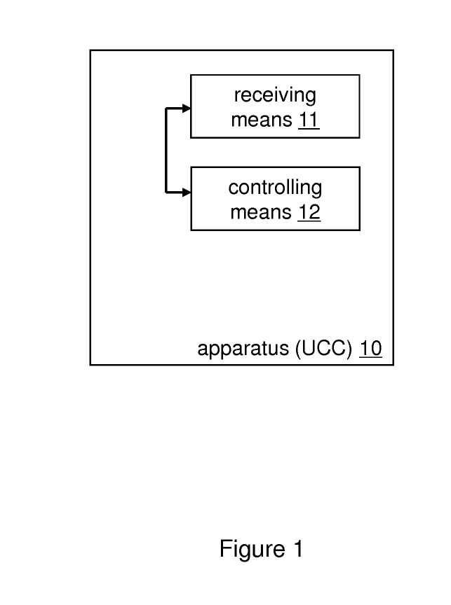

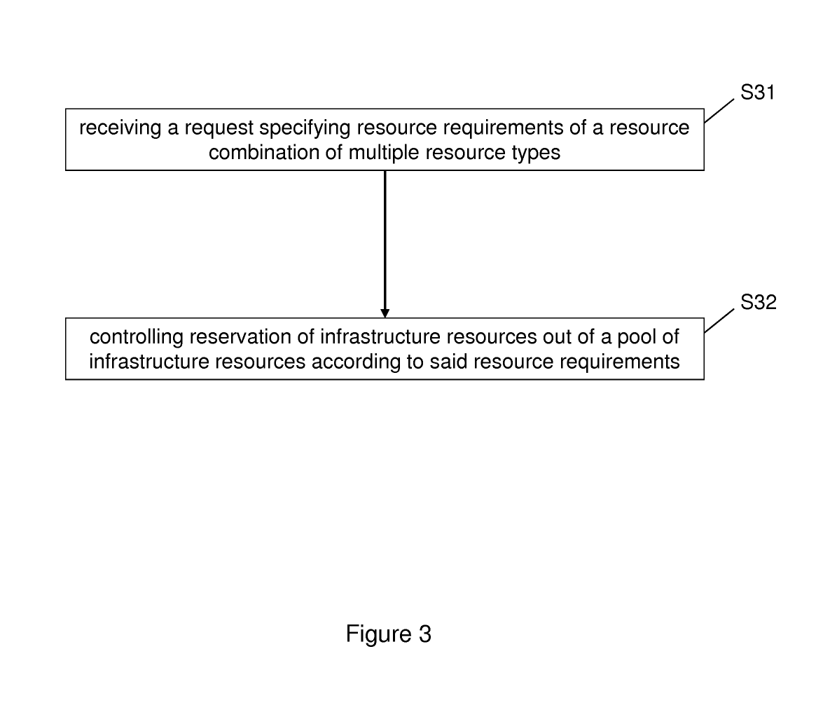

FIG. 1 is a block diagram illustrating an apparatus according to exemplary embodiments of the present invention. The apparatus may be a UCC 10 comprising a receiving means 11 and a controlling means 12. The receiving means 11 receives a request specifying resource requirements of a resource combination of multiple resource types. The controlling means 12 controls reservation of infrastructure resources out of a pool of infrastructure resources according to said resource requirements. FIG. 3 is a schematic diagram of a procedure according to exemplary embodiments of the present invention. The apparatus according to FIG. 1 may perform the method of FIG. 3 but is not limited to this method. The method of FIG. 3 may be performed by the apparatus of FIG. 1 but is not limited to being performed by this apparatus.

As shown in FIG. 3, a procedure according to exemplary embodiments of the present invention comprises an operation of receiving a request specifying resource requirements of a resource combination of multiple resource types (S31), and an operation of controlling reservation of infrastructure resources out of a pool of infrastructure resources according to said resource requirements (S32).

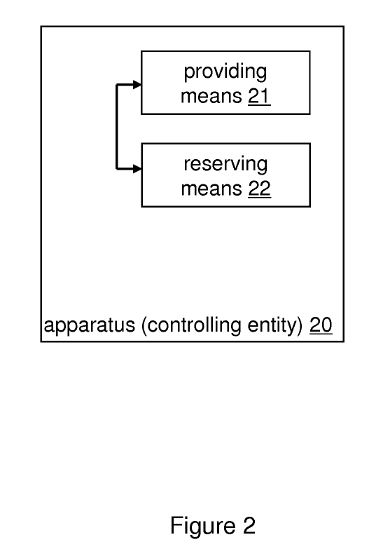

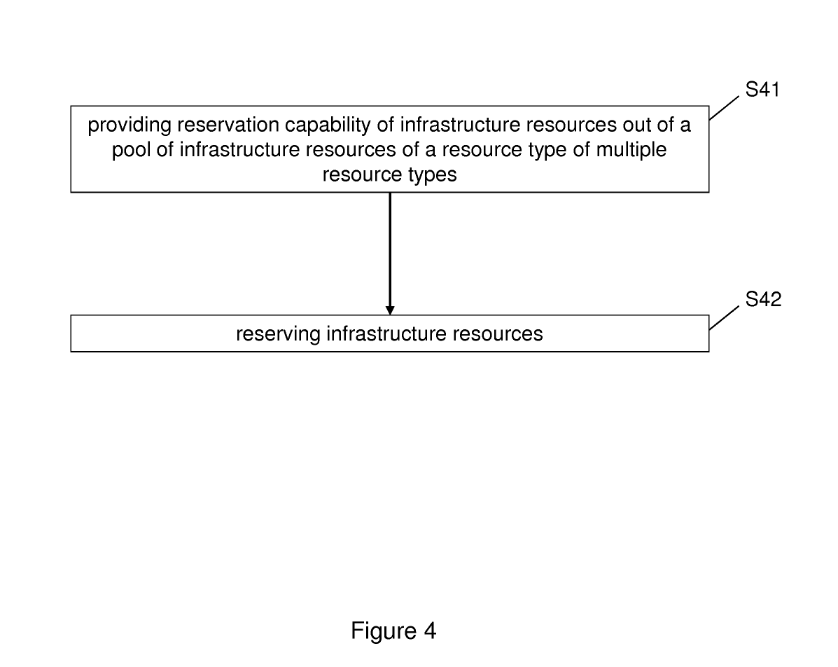

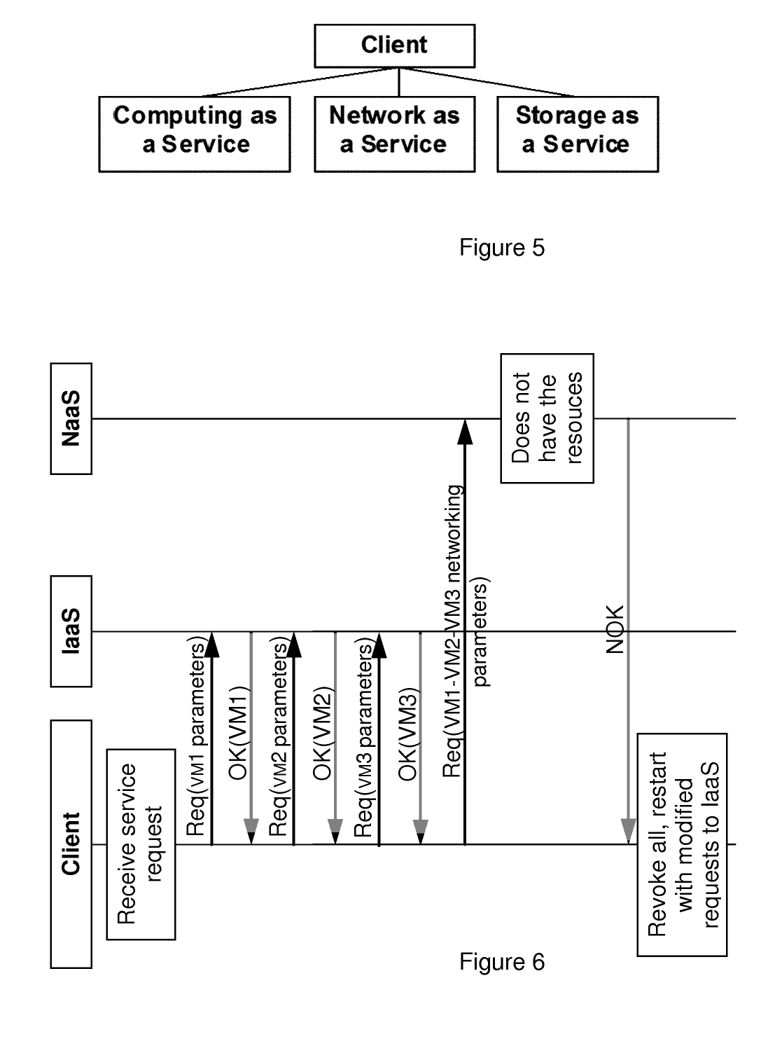

Further, FIG. 2 is a block diagram illustrating an apparatus according to exemplary embodiments of the present invention. The apparatus may be a controlling entity 20 such as an IaaS or a NaaS comprising a providing means 21 and a reserving means 22. The providing means 21 provides reservation capability of infrastructure resources out of a pool of infrastructure resources of a resource type of multiple resource types. The reserving means 22 reserves infrastructure resources. FIG. 4 is a schematic diagram of a procedure according to exemplary embodiments of the present invention. The apparatus according to FIG. 2 may perform the method of FIG. 4 but is not limited to this method. The method of FIG. 4 may be performed by the apparatus of FIG. 2 but is not limited to being performed by this apparatus.

As shown in FIG. 4, a procedure according to exemplary embodiments of the present invention comprises an operation of providing reservation capability of infrastructure resources out of a pool of infrastructure resources of a resource type of multiple resource types (S41), and an operation of reserving infrastructure resources (S42).

According to exemplary embodiments of the present invention, the UCC may take full responsibility of resource allocation. It implements the complete centralized resource allocation logic, and the existing NaaS and IaaS controllers merely execute the instructions.

The centralized control has the potential to provide closer to optimal usage of resources in the data center. For example, it will not happen that the majority of computing resources of a node (e.g. host machine A) are unused, but that node cannot be used in any subsequent deployment, as the networking resources of the node (i.e. host machine A) are already taken.

Note that in this alternative (according to the exemplary embodiments) the UCC is aware of the status of all controlled resource (the VM placement constraints: server availability, memory availability, etc.; networking constraints: bandwidth availability, network delay parameters, etc.) and makes deployment decisions based on those parameters aiming for optimal resource utilization. As the UCC is a quite complex functionality in this case, the usage of a single UCC may not be a feasible solution for large scale clouds.

Hence, according to a variation of the procedure shown in FIG. 3, exemplary details of the controlling operation are given, which are inherently independent from each other as such.

Such exemplary controlling operation according to exemplary embodiments of the present invention may comprise an operation of deciding infrastructure resources to be reserved based on a status of each infrastructure resource of said pool of infrastructure resources, and an operation of transmitting instructions to reserve said infrastructure resources to be reserved.

Further, according to exemplary embodiments of the present invention, said status may be at least one of a server availability, a memory availability, a bandwidth availability, and a network delay parameter.

Further, according to a variation of the procedure shown in FIG. 4, exemplary additional operations are given, which are inherently independent from each other as such. According to such variation, an exemplary method according to exemplary embodiments of the present invention may comprise an operation of receiving instructions to reserve said infrastructure resources to be reserved.

According to exemplary embodiments of the present invention, a distribution of subtasks between UCC, and existing IaaS and NaaS controller implementations is possible.

Namely, according to exemplary embodiments of the present invention, the UCC may be an entity that orchestrates the controllers of different resource types (e.g. NaaS for networking, IaaS for computing and storage), that is, the resource allocation logic is distributed between UCC and the controllers of each specific resource types (assuming legacy implementation is available and extendable).

That is, according to a variation of the procedure shown in FIG. 3, exemplary details of the controlling operation are given, which are inherently independent from each other as such.

Such exemplary controlling operation according to exemplary embodiments of the present invention may comprise an operation of orchestrating controlling entities respectively associated with each of said multiple resource types.

The interface between the UCC and specific resource controllers according to such exemplary embodiments of the present invention may be extended, for example, as follows. The resource mapping information is exchanged either directly between the resource controllers or via the UCC.

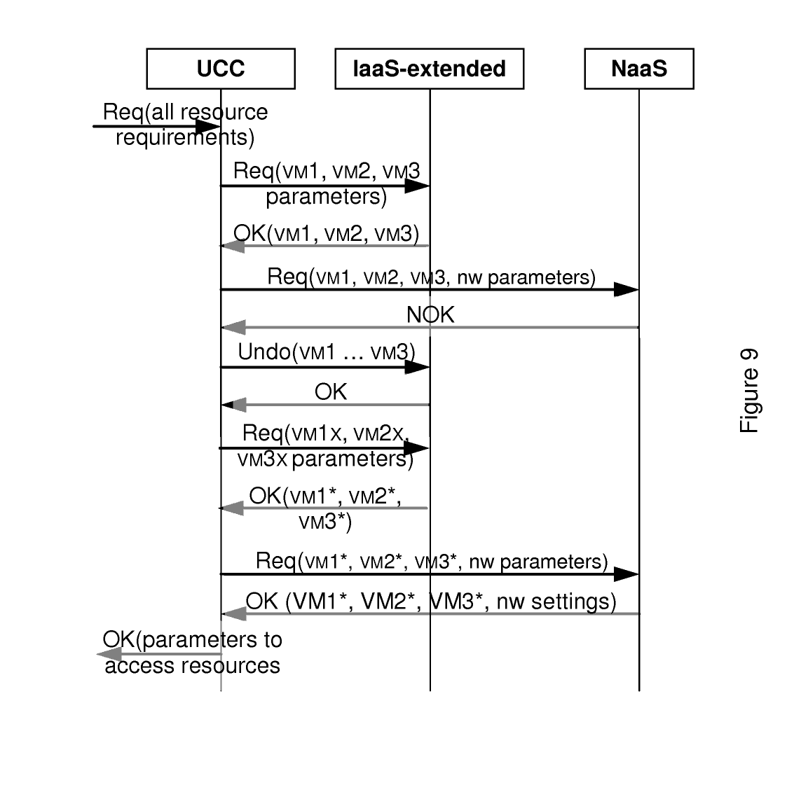

According to exemplary embodiments of the present invention, the fragmentation of resource reservation and thus the number of necessary steps to reserve resources is minimized, the UCC-IaaS interface is extended in a way that resource controllers can accept reservation requests containing a set of resources of the same type in one “atomic” operation. This solution may still require the need to revoke reservations as reservations are made in multiple steps, but the number of steps and thus the chances of try and error style operation is greatly reduced. According to such embodiments, the UCC does not control the resource allocation logic, it coordinates resource reservation, and if necessary, coordinates the trial and error mode of operation, so the users of the IaaS interface do not need to handle such operation (see FIG. 9). FIG. 9 presents a scenario where UCC groups resource requests towards specific resource controllers, and if necessary, coordinates subsequent resource reservation trials. In FIG. 9, VM1x, VM2x and VM3x indicate modified parameter, and VM1*, VM2* and VM3* indicate modified mapping.

In other words, according to a variation of the procedure shown in FIG. 3, exemplary details of the orchestrating operation are given, which are inherently independent from each other as such.

Such exemplary orchestrating operation according to exemplary embodiments of the present invention may comprise an operation of transmitting a first resource request containing a set of resource requirements of a first resource type.

According to a further variation of the procedure shown in FIG. 3, exemplary details of the orchestrating operation are given, which are inherently independent from each other as such.

Such exemplary orchestrating operation according to exemplary embodiments of the present invention may comprise an operation of transmitting a second resource request containing resources of said first type reserved based on said first resource request, and resource requirements of a second resource type, an operation of receiving a response indicative of acceptance or non-acceptance of said second resource request, and an operation of revoking, in case of non-acceptance, reservation of said resources of said first resource type.

Further, according to a variation of the procedure shown in FIG. 4, exemplary additional operations are given, which are inherently independent from each other as such. According to such variation, an exemplary method according to exemplary embodiments of the present invention may comprise an operation of receiving a resource request containing a set of resource requirements of said resource type.

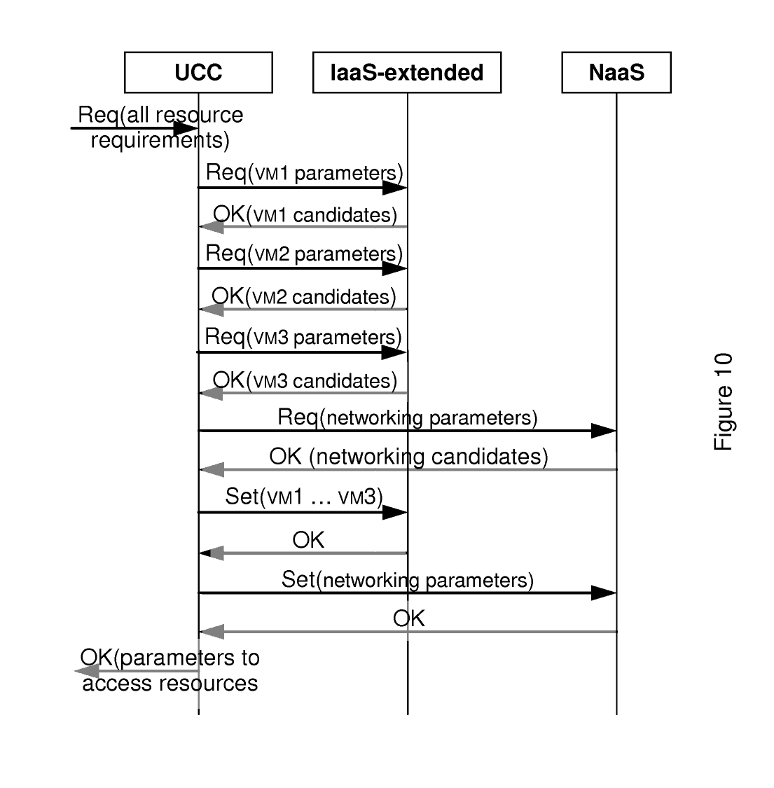

Alternatively, according to further exemplary embodiments of the present invention, in a two-step-solution, the controllers of each resource types (i.e. IaaS, NaaS) are extended to propose multiple mapping solutions (without reserving the actual resources) as a first step, based on the mapping proposals the UCC determines the final resource mapping, and sends back the selection to the resource controllers, which do the resource reservation at that point only (see FIG. 10). FIG. 10 presents a scenario where existing IaaS (NaaS) interface is extended to return a set of candidates (i.e., a set of resources that can fulfill the requested compute requirements), and the final selection of resources are made based on the proposed resources and networking requirements. In FIG. 10, “networking candidates” represents a set of mapping proposals that fulfill the requested networking parameters.

In other words, according to a variation of the procedure shown in FIG. 3, exemplary details of the orchestrating operation are given, which are inherently independent from each other as such.

Such exemplary orchestrating operation according to exemplary embodiments of the present invention may comprise an operation of receiving resource reservation proposals according to said resource requirements, an operation of determining, based on said resource reservation proposals, infrastructure resources to be reserved, and an operation of transmitting instructions to reserve said infrastructure resources to be reserved.

Further, according to a variation of the procedure shown in FIG. 4, exemplary additional operations are given, which are inherently independent from each other as such. According to such variation, an exemplary method according to exemplary embodiments of the present invention may comprise an operation of receiving a resource request containing resource requirements, an operation of transmitting resource reservation proposals based on said resource requirements, and an operation of receiving instructions to reserve said infrastructure resources to be reserved being determined based on said resource reservation proposals.

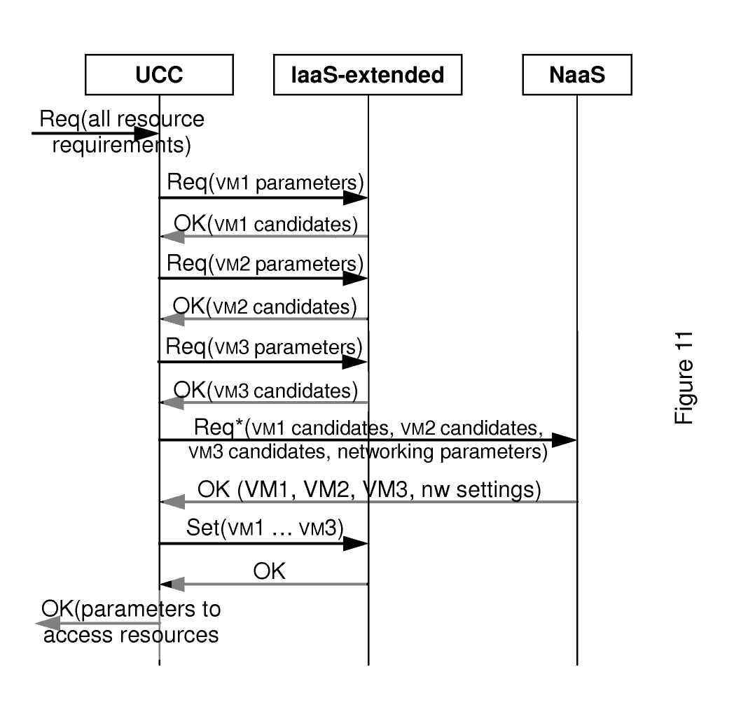

Alternatively, according to further exemplary embodiments of the present invention, in an alternative two-step-solution, the controllers of each resource types (e.g. IaaS, NaaS) are extended both to propose multiple resource mapping (without reserving the actual resources), and to accept resource restriction proposals in the resource reservation requests. It allows UCC to invoke each resource controller sequentially, and in subsequent requests the UCC may set restrictions based on previous resource mapping proposals. It also allows that the resource controller invoked at last can make the resource reservation (UCC can indicate that and UCC can invoke specific resource controllers in an appropriate order, so the last one does not need to implement the resource mapping proposal function, but only has to accept additional restrictions on resource reservation). As the resource mapping proposals from specific resource controllers are available, the UCC (and optionally the last invoked resource controller) makes the mapping, and the UCC informs the other resource controller(s) about the resource mapping made, and they in turn do resource reservation at that time (see FIG. 11). FIG. 11 presents a scenario where existing IaaS (NaaS) interface is extended (i) to return a set of candidates (i.e., a set of resources that can fulfill the requested compute requirements), (ii) to accept additional restrictions on mapping, and (iii) perform mapping if indicated. In FIG. 11, “Req*” represents the indication that the controller may perform resource mapping, in which case there is no need for sending mapping candidates.

In other words, according to a variation of the procedure shown in FIG. 3, exemplary details of the orchestrating operation are given, which are inherently independent from each other as such.

Such exemplary orchestrating operation according to exemplary embodiments of the present invention may comprise an operation of receiving, sequentially, resource reservation proposals according to said resource requirements, an operation of setting, based on previous resource reservation proposals, resource restrictions for resource requests, and an operation of transmitting a resource request including said resource restrictions.

Further, according to a variation of the procedure shown in FIG. 4, exemplary additional operations are given, which are inherently independent from each other as such. According to such variation, an exemplary method according to exemplary embodiments of the present invention may comprise an operation of receiving a resource request containing resource requirements and resource restrictions, wherein said reserving said infrastructure resources is performed based on said resource restrictions.

As discussed above, the architecture solution proposed according to exemplary embodiments of the present invention overcomes the problems identified above and provides a feasible solution for telecom grade clouds.

The proposed extension of IaaS API to accept complex resource requests can be detected and are a clear sign of using the present invention (it is assumed that this extended IaaS API will explicitly document the extensions).

If a data center offers hosting applications with QoS guarantees on networking, then it can be an indicator that the present invention is used.

NaaS and/or IaaS providing detailed information about available and allocated resources and allowing control on where a requested resource will be allocated may also be an indicator that the present invention is used.

According to exemplary embodiments of the present invention, UCC can act as an IaaS for (telecom grade) cloud, possibly on top of existing (and extended) IaaS implementations. Further, better and more efficient resource management in data centers, lower operational expenditure (OPEX) and capital expenditure (CAPEX) figures may be achieved.

The above-described procedures and functions may be implemented by respective functional elements, processors, or the like.

In the foregoing exemplary description of the entities, only the units that are relevant for understanding the principles of the invention have been described using functional blocks. The entities may comprise further units that are necessary for its respective operation. However, a description of these units is omitted in this specification. The arrangement of the functional blocks of the devices is not construed to limit the invention, and the functions may be performed by one block or further split into sub-blocks.

When in the foregoing description it is stated that the apparatus, i.e. entity (or some other means) is configured to perform some function, such function is to be construed to be equivalently implementable by specifically configured circuitry or means for performing the respective function (i.e. the expression “unit configured to” is construed to be equivalent to an expression such as “means for”).

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

The present invention also covers any conceivable combination of method steps and operations described above, and any conceivable combination of nodes, apparatuses, modules or elements described above, as long as the above-described concepts of methodology and structural arrangement are applicable.

In view of the above, there are provided measures for unified cloud resource control. Such measures exemplarily comprise receiving a request specifying resource requirements of a resource combination of multiple resource types, and controlling reservation of infrastructure resources out of a pool of infrastructure resources according to said resource requirements.

Even though the invention is described above with reference to the examples according to the accompanying drawings, it is to be understood that the invention is not restricted thereto. Rather, it is apparent to those skilled in the art that the present invention can be modified in many ways without departing from the scope of the inventive idea as disclosed herein.

### LIST OF ACRONYMS AND ABBREVIATIONS

API Application Programming Interface

CAPEX CAPital EXpenditure

CPU Central Processing Unit

IaaS Infrastructure as a Service

ID Identifier

IEEE Institute of Electrical and Electronics Engineers

IP Internet Protocol

NaaS Network as a Service

OPEX OPerational EXpenditure

OVF Open Virtualization Format

PaaS Platform as a Service

QoS Quality of Service

SW Software

UCC Unified Cloud resource Controller

VLAN Virtual Local Area Network

VM Virtual Machine

1.-26. (canceled)

27. A method comprising
receiving a request specifying resource requirements of a resource combination of multiple resource types, and
controlling reservation of infrastructure resources out of a pool of infrastructure resources according to said resource requirements.

28. The method according to claim 27, wherein
in relation to said controlling, said method further comprises
deciding infrastructure resources to be reserved based on a status of each infrastructure resource of said pool of infrastructure resources, and
transmitting instructions to reserve said infrastructure resources to be reserved.

29. The method according to claim 27, wherein
in relation to said controlling, said method further comprises
orchestrating controlling entities respectively associated with each of said multiple resource types.

30. The method according to claim 29, wherein
in relation to said orchestrating, said method further comprises
transmitting a first resource request containing a set of resource requirements of a first resource type.

31. The method according to claim 30, wherein
in relation to said orchestrating, said method further comprises
transmitting a second resource request containing
resources of said first resource type reserved based on said first resource request, and
resource requirements of a second resource type,
receiving a response indicative of acceptance or non-acceptance of said second resource request, and
revoking, in case of non-acceptance, reservation of said resources of said first resource type.

32. The method according to claim 29, wherein
in relation to said orchestrating, said method further comprises
receiving resource reservation proposals according to said resource requirements,
determining, based on said resource reservation proposals, infrastructure resources to be reserved, and
transmitting instructions to reserve said infrastructure resources to be reserved.

33. The method according to claim 29, wherein
in relation to said orchestrating, said method further comprises
receiving, sequentially, resource reservation proposals according to said resource requirements,
setting, based on previous resource reservation proposals, resource restrictions for resource requests, and
transmitting a resource request including said resource restrictions.

34. A method comprising
providing reservation capability of infrastructure resources out of a pool of infrastructure resources of a resource type of multiple resource types, and
reserving infrastructure resources.

35. The method according to claim 34, further comprising
receiving instructions to reserve said infrastructure resources to be reserved.

36. The method according to claim 34, further comprising
receiving a resource request containing a set of resource requirements of said resource type.

37. The method according to claim 34, further comprising
receiving a resource request containing resource requirements,
transmitting resource reservation proposals based on said resource requirements, and
receiving instructions to reserve said infrastructure resources to be reserved based on said resource reservation proposals.

38. The method according to claim 34, further comprising
receiving a resource request containing resource requirements and resource restrictions, wherein
said reserving said infrastructure resources is performed based on said resource restrictions.

39. An apparatus comprising
receiving means configured to receive a request specifying resource requirements of a resource combination of multiple resource types, and
controlling means configured to control reservation of infrastructure resources out of a pool of infrastructure resources according to said resource requirements.

40. The apparatus according to claim 39, further comprising
deciding means configured to decide infrastructure resources to be reserved based on a status of each infrastructure resource of said pool of infrastructure resources, and
transmitting means configured to transmit instructions to reserve said infrastructure resources to be reserved.

41. The apparatus according to claim 39, further comprising
orchestrating means configured to orchestrate controlling entities respectively associated with each of said multiple resource types.

42. The apparatus according to claim 41, further comprising
transmitting means configured to transmit a first resource request containing a set of resource requirements of a first resource type.

43. The apparatus according to claim 42, wherein
said transmitting means is further configured to transmit a second resource request containing
resources of said first type reserved based on said first resource request, and
resource requirements of a second resource type,
said receiving means is further configured to receive a response indicative of acceptance or non-acceptance of said second resource request, and the apparatus further comprising
revoking means configured to revoke, in case of non-acceptance, reservation of said resources of said first resource type.

44. The apparatus according to claim 42, wherein
said receiving means is further configured to receive resource reservation proposals according to said resource requirements, said apparatus further comprising
determining means configured to determine, based on said resource reservation proposals, infrastructure resources to be reserved, and
transmitting means configured to transmit instructions to reserve said infrastructure resources to be reserved.

45. The apparatus according to claim 42, wherein
said receiving means is further configured to receive, sequentially, resource reservation proposals according to said resource requirements, said apparatus further comprising
setting means configured to set, based on previous resource reservation proposals, resource restrictions for resource requests, and
transmitting means configured to transmit a resource request including said resource restrictions.
